(19) United States
(12) Patent Application Publication
(10) Pub. No.: US 2014/0218913 A1
(43) Pub. Date: Aug. 7, 2014

(54) LIGHTING DEVICE WITH INTEGRATED SLOT ANTENNA

(71) Applicant: GALTRONICS CORPORATION LTD., Tiberias (IL)

(72) Inventors: Randell COZZOLINO, Phoenix, AZ (US); Cliff CONNORS, Tempe, AZ (US); Brian HAHN, Gilbert, AZ (US)

(73) Assignee: GALTRONICS CORPORATION LTD., Tiberias (IL)

(21) Appl. No.: 14/172,520

(22) Filed: Feb. 4, 2014

Related U.S. Application Data
(60) Provisional application No. 61/760,236, filed on Feb. 4, 2013.

(51) Int. Cl. F21V 23/00; F21V 7/00

(52) U.S. Cl. CPC F21V 23/00; F21V 7/00; F21V 23/002
USPC 362/235; 362/249.01

(57) ABSTRACT

A lighting device including a housing, at least one light source housed by the housing, a conductive element mounted to the housing and having portions that define a slot, the slot forming a slot antenna radiating element for wireless control of the at least one light source and a feedline for feeding the slot antenna radiating element.

### REFERENCE TO RELATED APPLICATIONS

Reference is hereby made to U.S. Provisional Patent Application 61/760,236, entitled SLOT ANTENNA INTEGRATED WITH LIGHTING REFLECTOR, filed Feb. 4, 2013, the disclosure of which is hereby incorporated by reference and priority of which is hereby claimed pursuant to 37 CFR 1.78(a)(4) and (5)(i).

### FIELD OF THE INVENTION

The present invention relates generally to lighting devices and more particularly to lighting devices having antennas formed therein.

### BACKGROUND OF THE INVENTION

Various types of lighting devices having antennas formed therein are known in the art.

### SUMMARY OF THE INVENTION

The present invention seeks to provide a lighting device having a slot antenna integrally formed therein.

There is thus provided in accordance with a preferred embodiment of the present invention a lighting device including a housing, at least one light source housed by the housing, a conductive element mounted to the housing and having portions that define a slot, the slot forming a slot antenna radiating element for wireless control of the at least one light source and a feedline for feeding the slot antenna radiating element.

In accordance with a preferred embodiment of the present invention, the conductive element includes a reflector.

Preferably, the conductive element forms a part of the housing.

Preferably, the feedline capacitively feeds the slot antenna radiating element.

In accordance with another preferred embodiment of the present invention, the feedline is galvanically isolated from the conductive element and the slot.

Preferably, the feedline includes a coaxial cable having an inner conductive core, the inner conductive core being connected to a distributed feed element for feeding the slot antenna radiating element.

Preferably, the lighting device also includes a non-conductive carrier overlying the slot, the coaxial cable and the distributed feed element being disposed on the non-conductive carrier.

Preferably, the lighting device further includes a non-conductive cover disposed on the non-conductive carrier for concealing the coaxial cable and the distributed feed element.

Preferably, the conductive element includes an aperture formed therein in proximity to the slot, the inner conductive core being adapted for insertion in the aperture.

Preferably, the conductive element includes a pair of notches formed therein, the carrier being adapted to latch into the notches.

In accordance with a further preferred embodiment of the present invention, the slot has an electrical length generally equal to λ/2, where λ is a wavelength of radiation of the slot antenna radiating element.

Preferably, the slot is generally rectangular.

Alternatively, the slot is generally T-shaped.

In accordance with yet another preferred embodiment of the present invention, the at least one light source includes a multiplicity of light emitting diodes.

In accordance with yet a further preferred embodiment of the present invention, the conductive element is formed by sheet metal.

### BRIEF DESCRIPTION OF THE DRAWINGS

The present invention will be understood and appreciated more fully from the following detailed description, taken in conjunction with the drawings in which:

FIGS. 1A and 1B are simplified respective perspective partially assembled and assembled view illustrations of a lighting device constructed and operative in accordance with a preferred embodiment of the present invention;

FIGS. 1C and 1D are simplified respective expanded exploded view and underside assembled view illustrations of a portion of a lighting device of a type illustrated in FIGS. 1A and 1B;

FIG. 2 is a simplified perspective assembled view illustration of a lighting device constructed and operative in accordance with another preferred embodiment of the present invention; and

FIGS. 3A and 3B are simplified respective assembled and exploded view illustrations of a portion of a lighting device constructed and operative in accordance with a further preferred embodiment of the present invention.

### DETAILED DESCRIPTION OF PREFERRED EMBODIMENTS

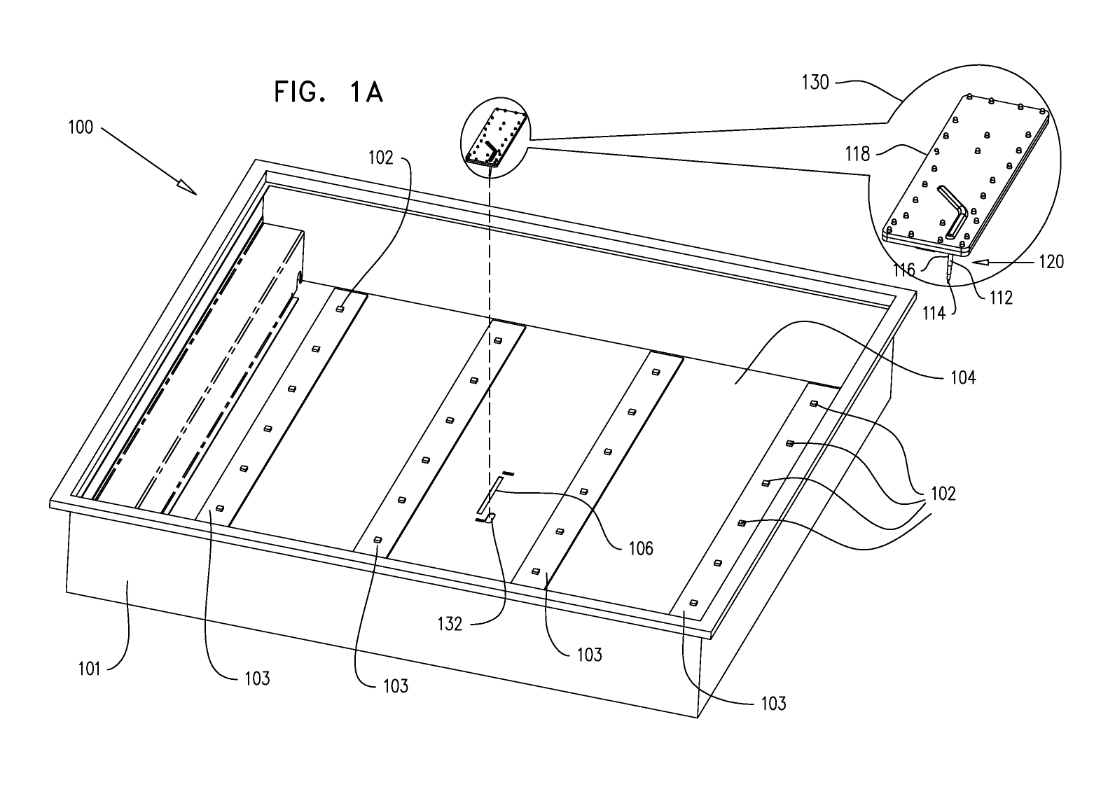

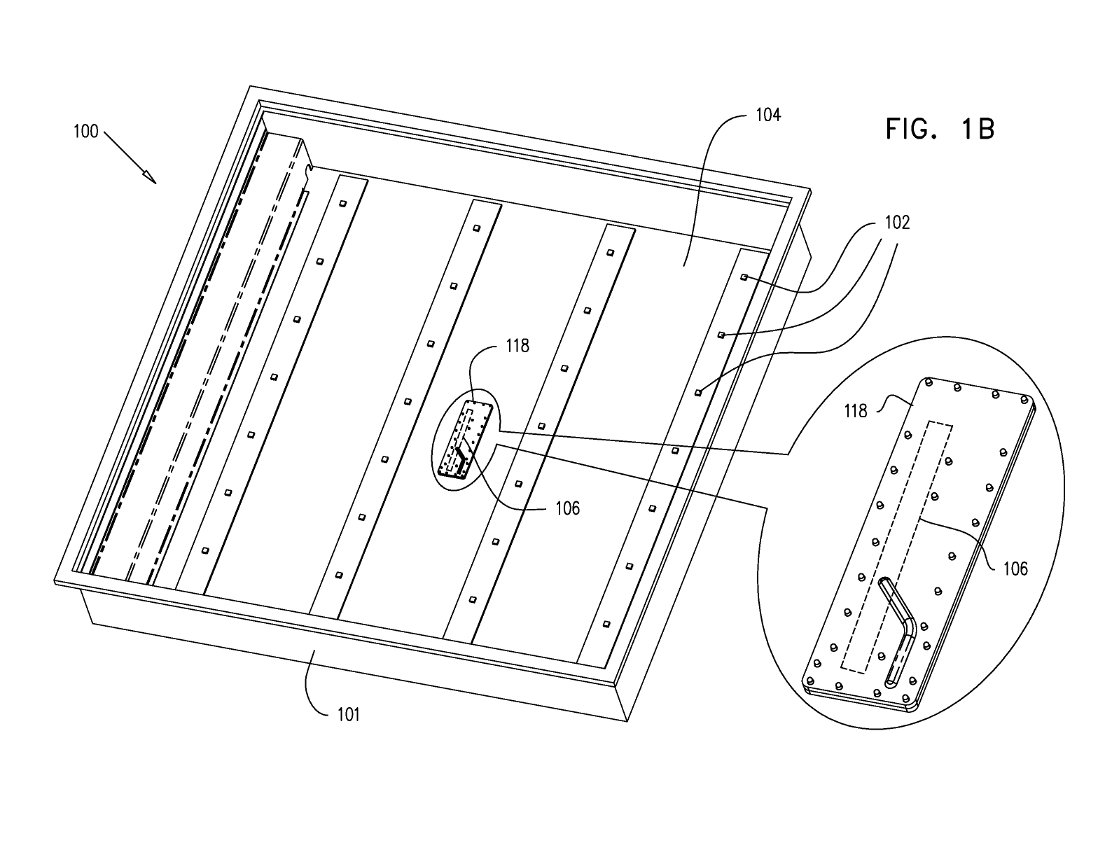

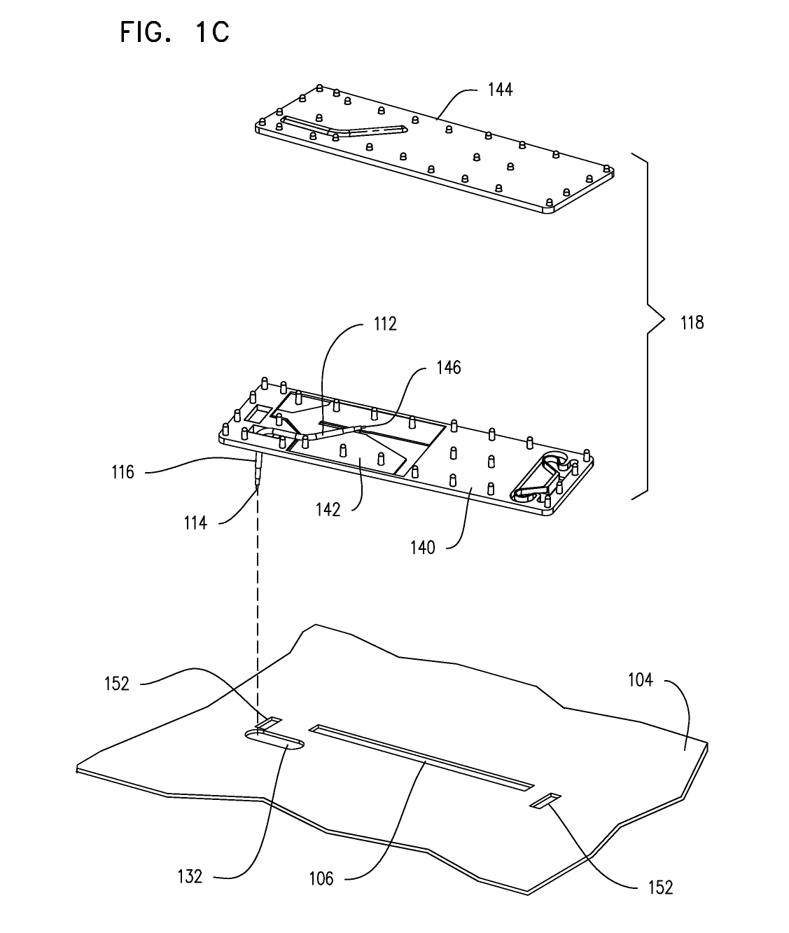

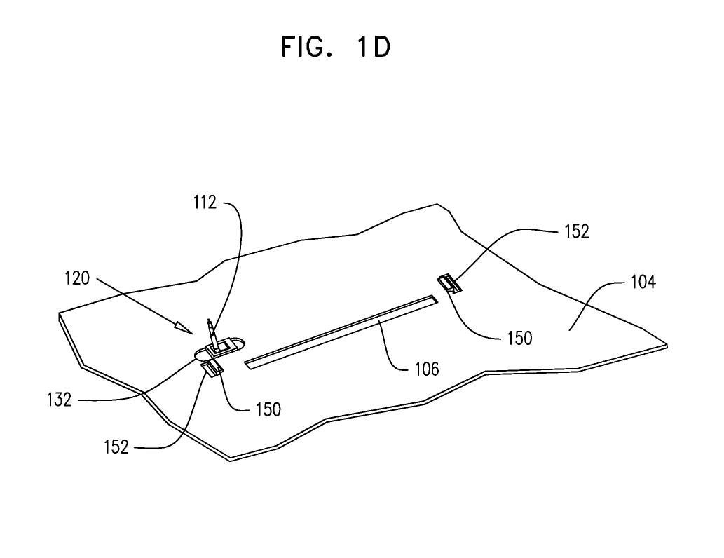

Reference is now made to FIGS. 1A and 1B, which are simplified respective perspective partially assembled and assembled view illustrations of a lighting device constructed and operative in accordance with a preferred embodiment of the present invention.

As seen in FIGS. 1A and 1B, there is provided a lighting device 100. Lighting device 100 preferably includes a housing 101 and at least one light source, here embodied, by way of example, as a plurality of light emitting diodes (LEDs) 102 housed by housing 101. In the illustrated embodiment of lighting device 100, plurality of LEDs 102 is seen to be arranged in a multiplicity of strips 103. It is appreciated, however, that a variety of types and numbers of light sources 102 may be employed in lighting device 100, including incandescent and fluorescent light sources, which light sources may be arranged in any suitable configuration.

Lighting device 100 further preferably includes a conductive element 104 mounted to housing 101 and having portions that define a slot 106. Here, by way of example, conductive element 104 is preferably embodied as a reflector 104 on which reflector 104 strips 103 of LEDs 102 are preferably disposed. Reflector 104 may form a part of housing 101 of lighting device 100 and is preferably operative to reflect and direct light emitted by LEDs 102. Reflector 104 is preferably formed by sheet metal. It is understood, however, that reflector 104 may alternatively be formed by other conductive materials, depending on the design requirements of lighting device 100.

It is a particular feature of a preferred embodiment of the present invention that slot 106 is preferably integrally formed within reflector 104 by portions of reflector 104. Slot 106 is preferably sized so as to resonate in a desired frequency band, thereby forming a slot antenna radiating element for wireless control and/or monitoring of LEDs 102.

It is understood that reflector 104 is a pre-existing feature of lighting device 100, serving to direct and reflect light emitted by LEDs 102, and is preferably not provided for the primary purpose of defining slot 106. It is a particular feature of a preferred embodiment of the present invention that slot 106 is preferably integrally formed within a pre-existing conductive feature of lighting device 100, which pre-existing feature may have a primary functional or aesthetic purpose other than defining slot 106 therein. This is in contrast to conventional arrangements of antennas incorporated within lighting devices, which conventional antennas are typically formed by additional dedicated conductive elements provided within the lighting device.

As a result of slot radiating element 106 being integrally formed within a pre-existing conductive feature of lighting device 100, the number of conductive parts within lighting device 100 is minimized, thereby making manufacture of the lighting device more cost-effective. Furthermore, slot radiating element 106 preferably does not obscure light emitted by light sources 102 and is mechanically robust, in comparison to conventional antennas formed by additional elements within lighting devices, which additional antenna elements tend to interfere with light emission and be more vulnerable to damage.

Slot radiating element 106 is preferably fed by way of a feed line 112. Feedline 112 preferably supplies a radio-frequency (RF) signal to slot radiating element 106 and is preferably galvanically isolated both from reflector 104 and slot radiating element 106. Here, by way of example, feed line 112 is preferably embodied as a coaxial cable 112 having an inner conductive core 114 and an outer insulative sheath 116. Coaxial cable 112 is preferably partially disposed within a feed assembly 118, such that a portion 120 of coaxial cable 112 preferably protrudes from feed assembly 118, as seen most clearly at enlargement 130 in FIG. 1A. Portion 120 of coaxial cable 112 is preferably adapted for insertion in a corresponding aperture 132 formed in reflector 104 in close proximity to slot radiating element 106, such that no conductive portion of coaxial cable 112 is in direct contact with reflector 104.

As seen in FIG. 1B, when lighting device 100 is in its assembled state feed assembly 118 is preferably disposed on reflector 104 so as to overlie slot radiating element 106. It is appreciated that due to the above-described arrangement of coaxial cable 112 with respect to slot radiating element 106, coaxial cable 112 is preferably galvanically isolated both from slot radiating element 106 and reflector 104 and preferably feeds slot radiating element 106 in a capacitive manner. Further details concerning the structure and operation of feed assembly 118 are provided henceforth with reference to FIGS. 1C and 1D.

The galvanic isolation of feedline 112 from the reflector 104 serves to ensure that reflector 104 is galvanically isolated from an alternating current (AC) power source to which feedline 112 is preferably connected. The galvanic isolation of feed line 112 from the reflector 104 thus prevents direct exposure of a user of lighting device 100 to AC current, thereby obviating a risk of an electric shock to the user. As a result, lighting device 100 is particularly safe for use by a consumer. Furthermore, the capacitive feed arrangement of slot radiating element 106 by coaxial cable 112 is particularly robust and less vulnerable to degradation in comparison to conventional direct galvanic feed arrangements.

Slot radiating element 106 preferably has an electrical length generally equal to λ/2, where λ is a wavelength of radiation in a desired frequency band of operation of slot radiating element 106. Slot radiating element 106 may operate over a frequency range of approximately 2.4-2.5 GHz and may have a physical length of approximately 50 mm. However, it is appreciated by one skilled in the art that the resonant frequency range of slot radiating element 106 may be readily modified by way of modifications to the dimensions of slot radiating element 106.

Reference is now made to FIGS. 1C and 1D, which are simplified respective expanded exploded view and underside assembled view illustrations of a portion of a lighting device of a type illustrated in FIGS. 1A and 1B

As seen in FIGS. 1C and 1D, slot radiating element 106 is preferably integrally formed within reflector 104 by portions of reflector 104 and is preferably fed by way of coaxial cable 112 disposed within feed assembly 118. As seen most clearly in FIG. 1C, feed assembly 118 preferably comprises a non-conductive carrier 140 having a conductive element 142 disposed thereon and a non-conductive cover 144 therefore. Coaxial cable 112 is preferably disposed on carrier 140 such that one end of inner conductive core 114 of coaxial cable 112 is preferably connected to conductive element 142 at a connection point 146. It is appreciated that due to the relative arrangement of slot radiating element 106, coaxial cable 112 and conductive element 142, conductive element 142 preferably forms a distributed feed element 142 for feeding slot radiating element 106. It is understood that due to the intervening presence of non-conductive carrier 140 between slot radiating element 106 and distributed feed element 142, distributed feed element 142 capacitively feeds slot radiating element 106.

The capacitive feeding of slot radiating element 106 by distributed feed element 142 is a particular feature of a preferred embodiment of the present invention. The distributed configuration of feed element 142 serves to improve an impedance match of slot radiating element 106 to a 50 Ohm input impedance, thus improving the efficiency of operation of slot radiating element 106.

It is a further particular feature of a preferred embodiment of the present invention that non-conductive cover 144 preferably conceals coaxial cable 112 and distributed feed element 142, such that no conductive portion of the feed arrangement of slot radiating element 106 is exposed on a surface of reflector 104 when lighting device 100 is in its assembled state. Lighting device 100 is thus particularly safe for use by consumers.

Feed assembly 118 may be mounted on a surface of reflector 104 by way of a pair of protrusions 150 preferably formed on an underside of carrier 140 and preferably adapted for latching into a corresponding pair of notches 152 preferably formed in reflector 104 flanking slot radiating element 106. It is appreciated, however, that the illustrated features for the mounting of feed assembly 118 on reflector 104 are exemplary only and that feed assembly 118 may be attached to a surface of reflector 104 by way of any other suitable techniques, as are well known in the art.

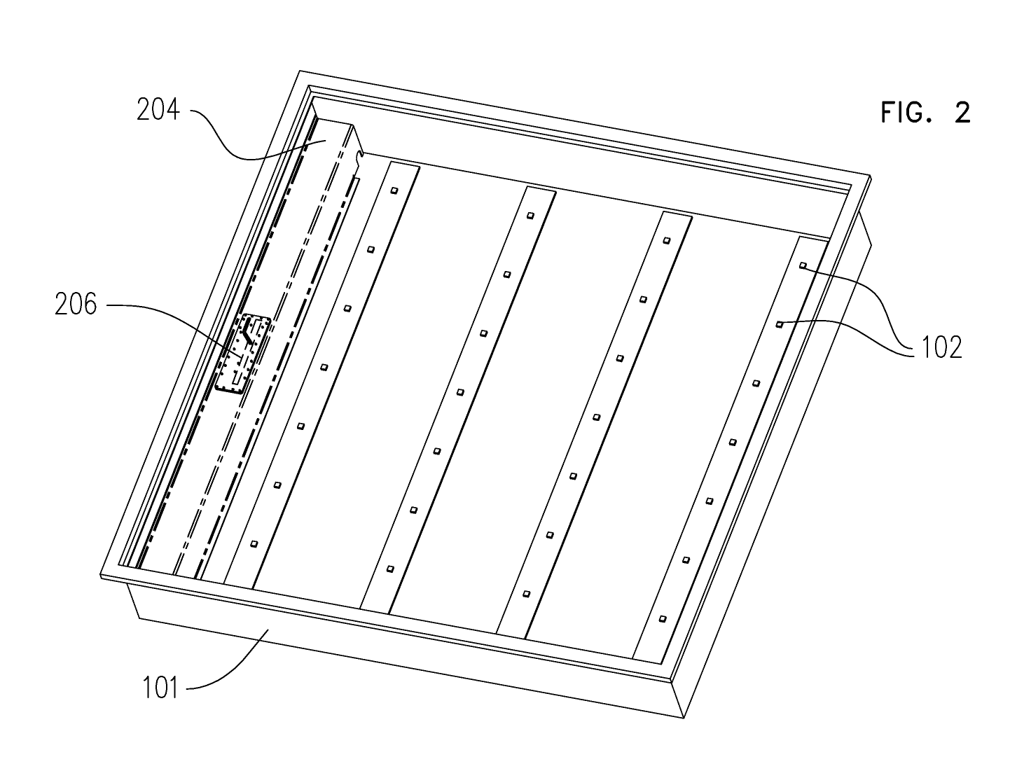

It is further appreciated that conductive element 104 having portions that define slot radiating element 106 is not limited to comprising a reflector of lighting device 100. Rather, conductive element 104 may comprise any pre-existing conductive portion of lighting device 100, provided that conductive element 104 is suitable for having slot radiating element 106 integrally formed therein. By way of example only, conductive element 104 may alternatively comprise a conductive electrical box cover, as seen in the case of a conductive electrical box cover 204 having portions defining a slot radiating element 206 shown in FIG. 2.

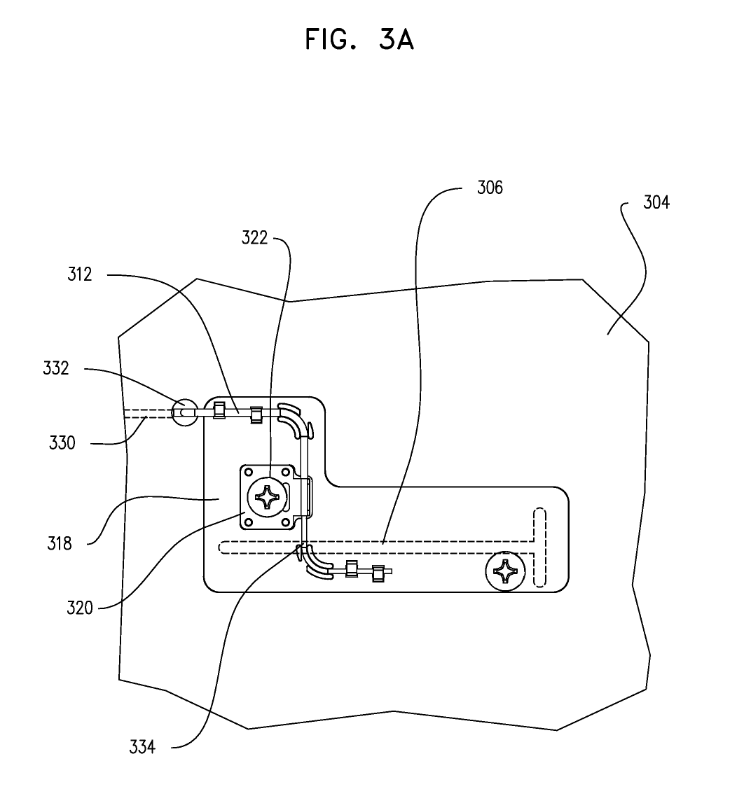

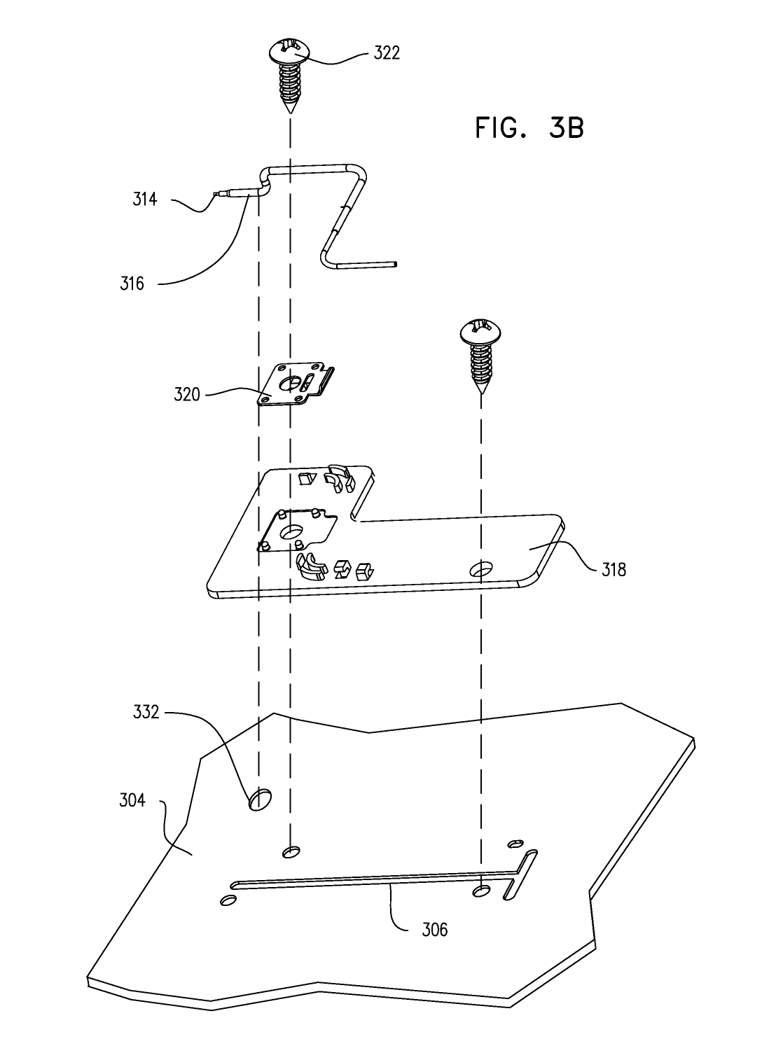

Reference is now made to FIGS. 3A and 3B, which are simplified respective assembled and exploded view illustrations of a portion of a lighting device constructed and operative in accordance with a further preferred embodiment of the present invention.

As seen in FIGS. 3A and 3B, there is provided a conductive element 304 preferably having portions defining a slot 306. It is appreciated that, for the sake of simplicity of presentation, only a portion of conductive element 304 is illustrated in FIGS. 3A and 3B. Conductive element 304 preferably comprises a portion of a conductive structure of a lighting device, such as conductive structures 104 and 204 respectively shown in FIGS. 1A-2. Conductive element 304 is preferably mounted to a housing of a lighting device, which housing preferably houses at least one light source.

Slot 306 is preferably sized so as to resonate in a desired frequency band, thereby forming a slot antenna radiating element for wireless control and/or monitoring of the at least one light source in the lighting device within which conductive element 304 may be incorporated. Slot 306 is preferably fed by a feed line 312, which feed line 312 is preferably operative to supply an RF signal to slot 306. Here, by way of example, feed line 312 is preferably embodied as a coaxial cable 312 having an inner conductive core 314 and an outer insulative sheath 316.

As seen most clearly in FIG. 3A, coaxial cable 312 is preferably disposed on a non-conductive feed assembly 318. Coaxial cable 312 may be mounted on feed assembly 318 by way of a metal clip 320. Metal clip 320 is preferably secured to a surface of feed assembly 318 by way of a non-conductive screw 322. Feed assembly 318 is preferably disposed on conductive element 304 so as to overlie slot radiating element 306, such that a portion 330 of coaxial cable 312 preferably protrudes through an aperture 332 in conductive element 304.

It is appreciated that due to the above-described arrangement of coaxial cable 312 with respect to conductive element 304, coaxial cable 312 is preferably galvanically isolated from conductive element 304 and slot 306. The galvanic isolation of feedline 312 from the conductive element 304 serves to ensure that conductive element 304 is galvanically isolated from an AC power source to which feedline 312 is preferably connected. The galvanic isolation of feed line 312 from the conductive element 304 thus prevents direct exposure of a user to AC current, thereby obviating a risk of an electric shock to the user. As a result, a lighting device incorporating slot antenna radiating element 306 is particularly safe for use by a consumer.

In order to further prevent direct exposure of a user to AC current, slot radiating element 306 is preferably enclosed by a cover, such as electrical box cover 204 shown in FIG. 2.

Due to the intervening presence of feed assembly 318 between coaxial cable 312 and slot radiating element 306, coaxial cable 312 preferably feeds slot radiating element 306 in a capacitive manner. The capacitive feed arrangement of coaxial cable 312 with respect to slot radiating element 306 is particularly mechanically robust and less vulnerable to degradation in comparison to conventional direct-contact galvanic feed arrangements.

Slot radiating element 306 preferably has an electrical length generally equal to λ/2, where λ is a wavelength of radiation in a desired frequency band of operation of slot radiating element 306. Slot radiating element 306 preferably has a T-shaped configuration, thereby allowing the physical length of slot radiating element 306 to be reduced whilst maintaining its electrical length. Slot radiating element 306 may operate over a frequency range of approximately 2.4-2.5 GHz and may have a physical length of approximately 35 mm. However, it is appreciated by one skilled in the art that the resonant frequency range of slot radiating element 306 may be readily modified by way of modifications to the dimensions of slot radiating element 306.

Coaxial cable 312 preferably crosses slot radiating element 306 at a point 334, such that a projection of coaxial cable 312 onto a surface of conductive element 304 lies upon slot radiating element 306. The location of intersection 334 preferably influences an impedance match of slot radiating element 306 to a 50 Ohm input impedance. It is understood that the location of intersection 334 may be readily modified depending on the impedance matching requirements of slot radiating element 306.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A lighting device comprising:
a housing;
at least one light source housed by said housing;
a conductive element mounted to said housing and having portions that define a slot, said slot forming a slot antenna radiating element for wireless control of said at least one light source; and
a feedline for feeding said slot antenna radiating element.

2. A lighting device according to claim 1, wherein said conductive element comprises a reflector.

3. A lighting device according to claim 1, wherein said conductive element forms a part of said housing.

4. A lighting device according to claim 2, wherein said reflector forms a part of said housing.

5. A lighting device according to claim 1, wherein said feedline capacitively feeds said slot antenna radiating element.

6. A lighting device according to claim 2, wherein said feedline capacitively feeds said slot antenna radiating element.

7. A lighting device according to claim 4, wherein said feedline capacitively feeds said slot antenna radiating element.

8. A lighting device according to claim 5, wherein said feedline is galvanically isolated from said conductive element and said slot.

9. A lighting device according to claim 8, wherein said feedline comprises a coaxial cable having an inner conductive core, said inner conductive core being connected to a distributed feed element for feeding said slot antenna radiating element.

10. A lighting device according to claim 9, and also comprising a non-conductive carrier overlying said slot, said coaxial cable and said distributed feed element being disposed on said non-conductive carrier.

11. A lighting device according to claim 10, and also comprising a non-conductive cover disposed on said non-conductive carrier for concealing said coaxial cable and said distributed feed element.

12. A lighting device according to claim 9, wherein said conductive element comprises an aperture formed therein in proximity to said slot, said inner conductive core being adapted for insertion in said aperture.

13. A lighting device according to claim 10, wherein said conductive element comprises a pair of notches formed therein, said non-conductive carrier being adapted to latch into said notches.

14. A lighting device according to claim 1, wherein said slot has an electrical length generally equal to λ/2, where λ is a wavelength of radiation of said slot antenna radiating element.

15. A lighting device according to claim 8, wherein said slot has an electrical length generally equal to λ/2, where λ is a wavelength of radiation of said slot antenna radiating element.

16. A lighting device according to claim 15, wherein said slot is generally rectangular.

17. A lighting device according to claim 14, wherein said slot is generally T-shaped.

18. A lighting device according to claim 1, wherein said at least one light source comprises a multiplicity of light emitting diodes.

19. A lighting device according to claim 1, wherein said conductive element is formed by sheet metal.

20. A lighting device according to claim 2, wherein said reflector is formed by sheet metal.
